(19) United States
(12) Patent Application Publication
(10) Pub. No.: US 2017/0028885 A1
(43) Pub. Date: Feb. 2, 2017

(54) VENTILATION UNIT FOR A VEHICLE SEAT

(71) Applicant: I.G. BAUERHIN GMBH, Gruendau (DE)

(72) Inventor: STEFAN BAUER, Alzenau (DE)

(21) Appl. No.: 15/207,789

(22) Filed: Jul. 12, 2016

(30) Foreign Application Priority Data
Jul. 28, 2015 (DE) 20 2015 005 265.7

(51) Int. Cl. B60N 2/56

(52) U.S. Cl. CPC B60N 2/5642; B60N 2/5657; B60N 2/5678; B60N 2/5692

(57) ABSTRACT

A ventilation unit for a vehicle seat has an air distribution layer that is at least on one side and is covered by a cover layer. A fan unit is held by a two-part adapter element—a first adapter part and a second adapter part—and has a flow connection to the air distribution layer via this adapter element. The first adapter part has a flange plate that is located between the air distribution layer and the cover layer and connection elements that extend starting at the flange plate through the cover layer and that connect to the second adapter part of the adapter element to which the fan unit is attached. The side of the cover layer that points away from the air distribution layer defines a positioning plane that receives a seat frame spring structure, which is delimited by parts of the second adapter part on the side that is opposite to the cover layer.

### BACKGROUND OF THE INVENTION

The present invention relates to a ventilation unit for a vehicle seat, for example a motor vehicle seat.

Such a ventilation unit includes an air distribution layer that is covered by a cover layer on at least one side. This air distribution layer is connected for one to a ventilating surface and for another to a fan unit. The fan unit comprising a fan and a fan housing either provides air to a surface to be ventilated or removes it from the same. The fan unit is held by a two-part adapter element having a first adapter part and a second adapter part. This adapter element also forms the flow connection between the air distribution layer and the fan unit. The adapter element is connected to parts of a seat frame spring structure.

DE 10 2007 017 000 A1 describes an air flow connector to be used in a vehicle seat air routing system. This air flow connector has a first section and a second section that are connected to each other. Connected to the first section is an air preparation device, for example, a thermoelectric device for heating or cooling air, while the second section is connected to an air distribution device assigned to a seat cushion. A part of the second section is formed as bellows to compensate for movements of the seat cushion that propagate to the air distribution device and thus to the air flow connector. The air flow connector for which the first section and the second section can also consist of one part is connected and held to a seat frame of the seat via the first section and clips arranged thereon by the clips engaging directly with parts of the seat frame.

DE 10 2006 004 465 A1 describes an insertion element for a ventilated vehicle seat to be arranged above a side of the seat or rest cushion that faces the occupant, with at least one air-permeable upper cover layer, a three-dimensional air distribution layer located below the same and at least one lower cover layer having at least one air inlet. A ring-shaped component with three sections is arranged at the at least one air inlet, wherein the first section includes a flange with which the component is held. The third section forms a fan receptacle and the second center section forms a structure that decouples the first and the third sections.

### SUMMARY OF THE INVENTION

The objective addressed, among others, by this invention is that of designing a ventilation unit that does justice to the requirements in a vehicle seat and, in particular, that it is easy to install.

This objective, as well as other objectives which will become apparent from the discussion that follows, are achieved, in accordance with the present invention by a ventilation unit having the features mentioned above and further characterized in that the first adapter part of the adapter element includes a flange plate that is arranged between the air distribution layer and the cover layer. Additionally, connection elements are present that extend starting at the flange plate through the cover layer and that connect to the second adapter part of the adapter element where the fan unit is attached. The side of the cover layer that points away from the air distribution layer, that is, also that side of the cover layer that is opposite that side where the flange plate is located, defines a positioning plane in which a seat frame spring structure extends. The positioning plane that receives a seat frame spring structure is delimited by parts of the second adapter part on the side that is opposite to the cover layer. Because the flange plate is positioned between the air distribution layer and the cover layer, the flange plate is separated towards a seat frame spring structure by the cover layer. Thus, direct friction between the flange plate and the seat frame spring structure does not occur. Preferably, the cover layer is made of a non-woven or a felt material, which, if required, may have an additional, further layer or coating that is impenetrable to air. Furthermore, no connection elements are required for hooking the adapter element directly to the seat frame spring structure because the seat frame spring structure is held between the two adapter parts in a positioning plane defined by the same. It is also essential that the positioning plane is defined by the plane of the flange plate, which is covered by the cover layer.

It is not necessary that the flange plate has to be fastened between the air distribution layer and the cover layer; rather it can be supported floating underneath the cover layer. The flange plate as part of the first adapter part can be secured in its position by elements that form the flow connection to the second adapter part and that extend starting from the flange plate through the cover layer. Such floating support of the flange plate simplifies the arrangement and the connection between the first adapter part to the air distribution layer. At the same time, such a floating support decouples the second adapter part, and because of it the adapter element, from the air distribution layer or a corresponding air distribution element.

In one preferred embodiment, a base plate as a portion of the second adapter part delimits the positioning plane that holds the seat frame spring structure. Consequently, the positioning plane for the seat frame spring structure is defined for one by the flange plate with the cover layer located above it and for another by the base plate. When the first adapter part is connected to the second adapter part, the seat frame spring structure is received in this plane between the flange plate of the first adapter part and the base plate of the second adapter part thus securing the adapter element at the seat frame spring structure.

The second adapter part may have a fan receptacle receiving the fan housing such that a typical fan unit consisting of a fan and fan housing can be inserted into the second adapter part. The second adapter part has openings and connection components for this purpose that form a flow connection between the fan and the adapter part and that hold the fan unit at the second adapter part.

The connection elements that extend starting from the flange plate of the first adapter part through the cover layer and connect to the second adapter part can preferably be formed by connection hooks. However, other snap-in elements at the first adapter part and the second adapter part are also possible that snap in to engage with each other and in doing so hold the adapter element at the seat frame spring structure that extends into the positioning plane that is intended for that purpose.

The first adapter part and/or the second adapter part can have at least one tube-shaped extension. Such an extension that also serves as a flow connection between the first adapter part and the second adapter part snaps into the respective other adapter part.

In one embodiment considered particularly preferred, the one and/or the other adapter part has multiple extensions that in particular serve the purpose of forming a centering aid at one seat frame spring structure through their arrangement and orientation. For this purpose, extensions are positioned such that parts of the seat frame spring structure pass through between the extensions. The parts of the spring structure should have a sufficient side distance relative to the positioning plane to the extensions such that they do not touch the spring structure.

If multiple extensions are used, then the flow connection between the fan and the air distribution layer can be comprised of the channel cross-section of at least one portion of these extensions.

If both the first and the second adapter part have such extensions, then these are designed such that they engage with each other. With such a structure, it may be advantageous that the tube-shaped extensions have the connection elements that engage with each other and lock such that no additional connection elements are necessary to connect the first adapter part and the second adapter part to each other. However, additional connection elements that engage with each other can be provided at the first adapter part and the second adapter part.

Preferably, connection elements are formed at the tube-shaped extensions by circumferential noches, grooves or protrusions.

To position the flange plate between the air distribution layer and the cover layer, in particular also for their floating support between the air distribution layer and the cover layer, the flange plate is inserted into the cover layer via an insertion slot. This simplifies the installation procedure significantly, in particular because no additional means of attachment are necessary to connect the first adapter part to the air distribution layer.

In another embodiment of the ventilation unit, the fan housing is allocated as an intermediate part to the second adapter part such that only one fan needs to be placed into the second adapter part; the intermediate part and the fan then form the fan unit.

For a full understanding of the present invention, reference should now be made to the following detailed description of the preferred embodiments of the invention as illustrated in the accompanying drawings.

### BRIEF DESCRIPTION OF THE DRAWINGS

FIG. 1 is a perspective view of a ventilation unit for a vehicle seat, partially in an exploded presentation, with an indicated plane of a seat frame spring structure.

FIG. 2 is a view from the direction of the sight arrow II in FIG. 1.

FIG. 3 shows an adapter element in an exploded presentation with a first adapter part and a second adapter part, as is also used in the ventilation unit of FIG. 1.

FIG. 4 shows the second adapter part of FIG. 3 in an exploded presentation with a fan unit separated from the same.

FIG. 5 is a top view of a seat frame spring structure from which the possible arrangement of the first adapter part, as shown in FIG. 1.

FIG. 6 is an alternative embodiment of the first adapter part of an adapter element.

### DETAILED DESCRIPTION OF THE PREFERRED EMBODIMENTS

The preferred embodiments of the present invention will now be described with reference to FIGS. 1-6 of the drawings. Identical elements in the various figures are designated with the same reference numerals.

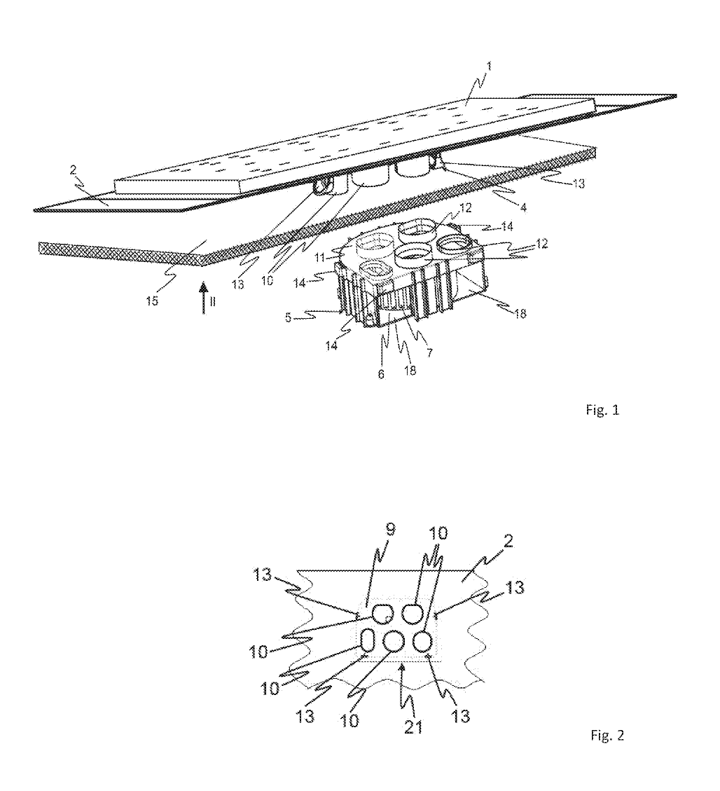

As FIGS. 1 and 2 initially show, the ventilation unit according to the invention that is provided to ventilate a vehicle seat comprises an air distribution layer 1 that is covered on its one side with a cover layer 2. A layer permeable to air made of a non-woven, a foam material or a cellular rubber but also of a knitted spacer fabric can be used as the air distribution layer 1. The cover layer 2 can be made of a foil or preferred of a non-woven or a material similar to a non-woven; it is also advantageous to combine several layers for the cover layer 2, for example, to provide the cover layer 2 with airtight, soft or pliable properties.

A fan unit has a flow connection to the air distribution layer 1 via a two-part adapter element 3 comprising a first adapter part 4 and a second adapter part 5.

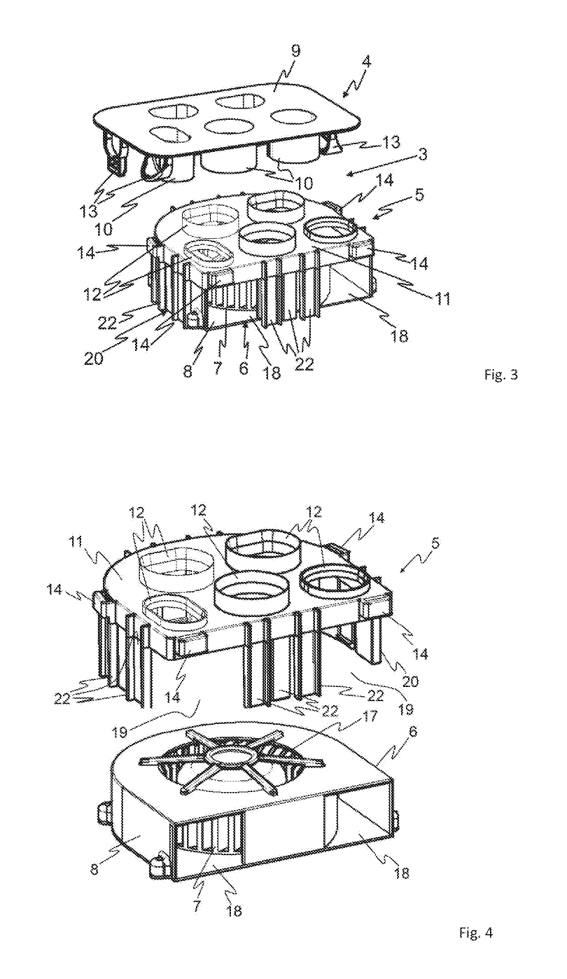

The adapter element 3 with the two adapter parts 4, 5 is shown in an enlarged presentation in FIG. 3. A fan unit 6, which is shown in FIG. 4 together with the second adapter part 5, separate from the same in an additional exploded presentation, is placed into the second adapter part 5.

The fan unit 6 shown in FIG. 4 includes a fan 7 in a fan housing 8.

The first adapter part 4 of the adapter element 3 is built from a flange plate 9, which is essentially an even, flat plate, as is shown in particular in FIG. 3. Multiple tube-shaped extensions 10 extend from the one side of this flange plate 9 and are arranged in a certain pattern across the surface of the flange plate 9. Preferably, these extensions 10 are oriented with their tube axes perpendicular to the plane of the flange plate 9. In the embodiment as shown in FIGS. 1 to 5, the first adapter part 4 comprises five of these tube-shaped extensions 10 in two rows of two and three respectively that are furthermore offset from each other.

The second adapter part 5 of the adapter element 3 has a base plate 11 with tube-shaped extensions 12 arranged on one side thereon corresponding to the first adapter part 4 and corresponding in their position to the tube-shaped extensions 10 of the first adapter part 4. The dimensions of these tube-shaped extensions 12 are selected such that they fit around the outer circumference of the tube-shaped extensions 10 or can be inserted into the inner circumference of the tube-shaped extensions 10.

The first adapter part 4 and the second adapter part 5 of the adapter element 3 can be connected to each other via locking elements that engage with each other. These connection elements can engage with each other such that they snap together using respective locking elements. In the exemplary embodiment presented in FIGS. 1 to 5, spring arms 13 that may have snap tabs at their ends are present at the first adapter part 4 and that engage into corresponding grooves or slots 14 at the second adapter part 5. The grooves or slots 14 are located at the outer circumference of the base plate 11 of the second adapter part 5. However, it is also provided that the grooves or slots 14 are assigned to the first adapter part 4 and the spring arms 13 to the second adapter part 5 or that part of the grooves or slots 14 and part of the spring arms 13 belong to the first adapter part 4 and a part to the second adapter part 5.

In addition to the snapping in spring arms 13 or other such snap-in elements, or as an alternative to them, the connecting elements that engage with each other in a snap-in fashion can be assigned to the tube-shaped extensions 10 of the first adapter part 4 and/or to the tube-shaped extensions 12 of the second adapter part 5 by forming notches or grooves, preferably circumferential notches or grooves.

The tube-shaped extensions of the first adapter part 4 and of the second adapter part 5 of the adapter element 3 shown in FIGS. 1 to 6 are exemplary with regard to shape and number and not limiting. The embodiment of the tube-shaped extensions is preferably selected such that when the first adapter part 4 and the second adapter part 5 are connected to each other, they are connected preventing rotation and at the same time in a fixed orientation to each other.

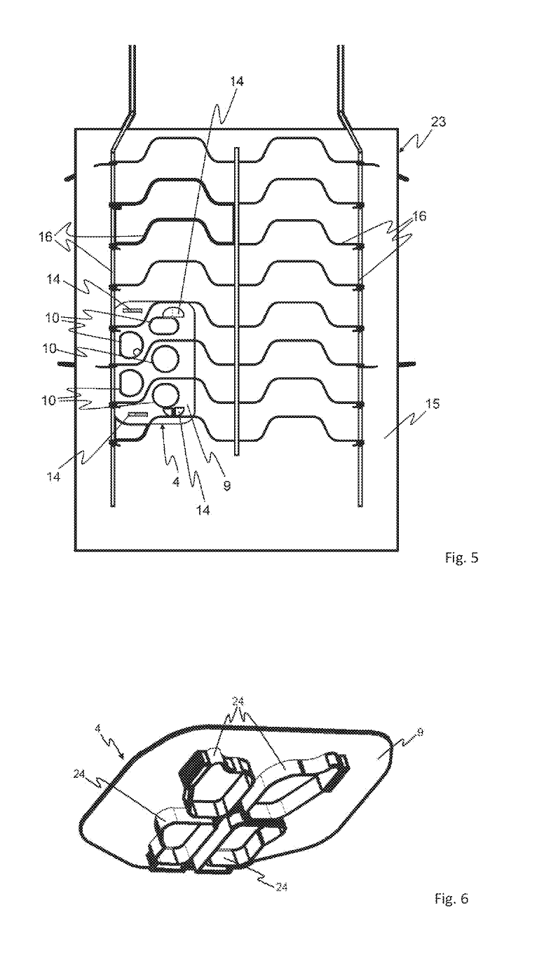

The adapter element 3 is connected to a seat frame spring structure 16, which is shown schematically in FIG. 5. The side of the cover layer 2 that is pointing away from the air distribution layer 1 and has the flange plate 9 placed behind it serves as the positioning plane 15 for this purpose and is indicated in FIG. 1. The seat frame spring structure 16 extends along this positioning plane 15 and is enclosed between the flange plate 9 of the first adapter part 4 and the base plate 11 of the second adapter part 5; at the same time, the tube-shaped extensions 10 and/or 12 at the first adapter part 4 and the second adapter part 5 serve the purpose of centering the adapter element 3 in the positioning plane 15 at the springs of the seat frame spring structure in that the individual spring bars or spring components run in the interim spaces between the tube-shaped extensions 10, 12. This arrangement is shown schematically in FIG. 5; it shows schematically a seat or backrest area 23 with a seat frame spring structure 16 and a possible positioning of the first adapter part 4; it should be noted that the cover layer 2 is not shown in FIG. 5.

As can be seen based on the exploded drawing of FIG. 4, the entire fan unit 6, that is, the fan 7 with the fan housing 8, is placed into the second adapter part 5 in the shown embodiment. In this arrangement, an axial housing opening 17 has a flow connection to at least a portion of the openings of the tube-shaped extensions 12, while a radial housing opening 18 is assigned to an opening 19 in a side wall 20 of the second adapter part 5. Through respective attachment and support elements at the second adapter part 5 and/or at the fan housing 8 of the fan unit 6, the same can be inserted in a simple manner into the second adapter part 5 and also removed again if a replacement is necessary.

However, as an alternative to the shown embodiment, it is also provided to integrate the fan housing 8 as a fixed component of the second adapter part 5 such that the air guidance between the fan housing 8, which could then also be designated as fan adapter housing, and the openings is defined according to the tube-shaped extensions 12. The housing integrated into the second adapter part 5 then forms an interim part. It is then only necessary to use one fan in the fan adapter housing such that the arrangement is independent of the shape of a fan housing of a fan unit 6.

Additional webs and grooves 22, for example, guide webs and/or guide grooves can be provided at the second adapter part 5, preferably at the external side of the base plate 11 and at the external side of the housing wall 20 and that brace the second adapter part 5 and if necessary can serve as an additional guide element.

One significant feature of the ventilation unit is that the flange plate 9, which is a part of the first adapter part 4, is preferably supported floating between the air distribution layer 1 and the cover layer 2 by being neither glued together with the air distribution layer 1 or the cover layer 2. Another particular advantage is that the first adapter part 4 can be inserted between the air distribution layer 1 and the cover layer 2 via an insertion slot 21 in the cover layer 2, which is indicated in FIG. 2. The tube-shaped extensions 10, that extend from the flange plate 9 of the first adapter part 4, then pass through respective openings in the cover layer 2 such that the bottom side of the cover layer 2 rests on the top side of the flange plate 9. In this manner, the first adapter part 4 can be connected to the air distribution layer 1 and the cover layer 2 without additional means for fastening and is additionally supported floating and is centered. At the same time, the cover layer 2 forms a contact surface for the seat frame spring structure 16 that rests on it when the first adapter part 4 is connected to the second adapter part 5. If required, the insertion slot 21 can be closed using a sealing strip, for example, an adhesive tape strip, which is, however, not presented in the figures. It is also possible to glue the edges of the insertion slot 21 together.

While in the embodiment of FIGS. 1 to 5, the adapter element 3 has five tube-shaped extensions 10, with corresponding extensions 12 on the base plate 11 of the second adapter part 5, FIG. 6 shows an alternative embodiment with four tube-shaped extensions 24 to demonstrate that the number and shape of the tube-shaped extensions can vary within the scope of the inventive idea. A second adapter part 5 of the adapter element 3 is appropriately adapted as demonstrated in FIGS. 1 to 5 to the first adapter part 4 that is presented in FIG. 6.

There has thus been shown and described a novel ventilation unit for a vehicle seat which fulfills all the objects and advantages sought therefor. Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

What is claimed is:

1. A ventilation unit for a vehicle seat having an air distribution layer that is covered at least on the one side by a cover layer, and having a fan unit, comprising a fan and a fan housing, which is held by a two-part adapter element with a first adapter part and a second adapter part and is in a flow connection with the air distribution layer via this adapter element, wherein means are provided for connecting the adapter element to parts of a seat frame spring structure, the improvement wherein the first adapter part of the adapter element has a flange plate, which is arranged between the air distribution layer and the cover layer, and connection elements that extend, starting at the flange plate, through the cover layer and connect to the second adapter part of the adapter element, where the fan unit is attached; wherein the side of the cover layer facing away from the air distribution layer defines a positioning plane that receives a seat frame spring structure;
and wherein the positioning plane is delimited on the side opposite the cover layer by parts of the second adapter part.

2. Ventilation unit as in claim 1, wherein a base plate of the second adapter part delimits the positioning plane that receives the seat frame spring structure.

3. Ventilation unit as in claim 1, wherein the second adapter part has fan receptacle that receives the fan housing.

4. Ventilation unit as in claim 1, wherein the connection elements are formed by connection hooks.

5. Ventilation unit as in claim 1, wherein at least one of the first adapter part and the second adapter part has at least one tube-shaped extension that engages with the respective other adapter part.

6. Ventilation unit as in claim 5, wherein the tube-shaped extension has connection elements that lock as they engage with each other.

7. Ventilation unit as in claim 6, wherein the connection elements are formed by circumferential elements selected from the group consisting of notches, grooves or protrusions.

8. Ventilation unit as in claim 2, wherein the flange plate is supported, floating between the air distribution layer and the cover layer.

9. Ventilation unit as in in claim 8, wherein the flange plate is inserted via an insertion slot into the cover layer between the air distribution layer and the cover layer.

10. Ventilation unit as in claim 1, wherein the fan housing forms an interim part in the second adapter part where the fan can be placed removably.

11. Ventilation unit as in claim 5, wherein multiple tube-shaped extensions are provided that form a centering aid at the seat frame spring structure.
